(19) United States
(12) Patent Application Publication
(10) Pub. No.: US 2019/0048450 A1
(43) Pub. Date: Feb. 14, 2019

(54) WIRE MATERIAL FOR CONNECTOR TERMINAL

(71) Applicants: Sumitomo Electric Industries, Ltd., Osaka-shi (JP); Sumitomo Electric Toyama Co., Ltd., Imizu-shi (JP)

(72) Inventors: Kei Sakamoto, Osaka-shi (JP); Akiko Inoue, Osaka-shi (JP); Tetsuya Kuwabara, Osaka-shi (JP); Taichiro Nishikawa, Osaka-shi (JP); Kiyotaka Utsunomiya, Osaka-shi (JP); Minoru Nakamoto, Osaka-shi (JP); Yusuke Oshima, Osaka-shi (JP); Hitoshi Tsuchida, Imizu-shi (JP); Dai Kamogawa, Imizu-shi (JP)

(21) Appl. No.: 16/078,736

(22) PCT Filed: Feb. 16, 2017
(86) PCT No.: PCT/JP2017/005769

§ 371 Date: Aug. 22, 2018

(30) Foreign Application Priority Data
Feb. 22, 2016 (JP) 2016-031324
Dec. 12, 2016 (JP) 2016-240702

(51) Int. Cl. C22F 1/08; C22C 9/00; H01B 5/02; H01R 13/03; H01B 1/02; C22C 1/02

(52) U.S. Cl. CPC C22F 1/08; C22C 9/00; C22C 1/02; H01R 13/03; H01B 1/026; H01B 5/02

(57) ABSTRACT

A wire material for a connector terminal contains 0.1% to 1.5% by mass of Fe, 0.05% to 0.7% by mass of Ti, and 0% to 0.5% by mass of Mg, with the balance being Cu and impurities.

### TECHNICAL FIELD

The present invention relates to a wire material for a connector terminal.

The present application is based upon and claims the benefit of priority from Japanese Patent Application No. 2016-031324, filed Feb. 22, 2016, and Japanese Patent Application No. 2016-240702, filed Dec. 12, 2016, the entire contents of which are incorporated herein by reference.

### BACKGROUND ART

A press-fit terminal is one example of a connector terminal (for example, refer to Patent Literature 1). The press-fit terminal is a rod-shaped material that can be connected to a printed circuit board in a solderless manner. By connecting one end of a press-fit terminal to a counter member and press-fitting the other end thereof in a printed circuit board, the counter member and the printed circuit board can be electrically and mechanically connected to each other.

The constituent material for the connector terminal may be pure copper, such as tough pitch copper; a copper alloy, such as brass; or iron ([0026] of Patent Literature 1, etc). In addition, as a material having an excellent spring property, phosphor bronze or the like may be used.

### CITATION LIST

### Patent Literature

PTL 1: Japanese Unexamined Patent Application Publication No. 2014-149956

### SUMMARY OF INVENTION

A wire material for a connector terminal according to the present disclosure contains 0.1% to 1.5% by mass of Fe, 0.05% to 0.7% by mass of Ti, and 0% to 0.5% by mass of Mg, with the balance being Cu and impurities.

### DESCRIPTION OF EMBODIMENTS

### Problems to be Solved by the Present Disclosure

A connector terminal, such as a press-fit terminal, is required to have an excellent conductive property, high rigidity, and a high spring property. Accordingly, the materials for such a connector terminal are required to have an excellent conductive property and high strength.

The above-described tough pitch copper and brass have an excellent conductive property but low strength and a poor spring property. The above-described iron and phosphor bronze have high strength and an excellent spring property but a low conductivity. Such materials cannot sufficiently meet the requirement for excellence in both the conductive property and strength.

Recently, along with reduction in size and thickness of electrical/electronic devices, reduction in size of components has been required. In order to form a smaller connector terminal, even in the case where the cross-sectional area of a wire material is decreased or a wire material is thinned, a wire material having an excellent conductive property and higher strength is required so that a connector terminal having an excellent conductive property and high strength can be formed.

Accordingly, one object is to provide a wire material for a connector terminal that can form a connector terminal having an excellent conductive property and high strength.

### Advantageous Effects of the Present Disclosure

The wire material for a connector terminal according to the present disclosure can form a connector terminal having an excellent conductive property and high strength.

[Description of Embodiments of the Present Invention]

First, the contents of embodiments of the present invention will be enumerated and described.

(1) A wire material for a connector terminal according to an embodiment of the present invention contains 0.1% to 1.5% by mass of Fe, 0.05% to 0.7% by mass of Ti, and 0% to 0.5% by mass of Mg, with the balance being Cu and impurities.

The wire material for a connector terminal is composed of a copper alloy having a specific composition and, therefore, has an excellent conductive property, high strength, excellent rigidity, and an excellent spring property. The reason for this is that, in the copper alloy, Fe and Ti exist as precipitates or crystallized products containing Fe and Ti, typically, as compounds, such as Fe₂Ti, in the Cu phase serving as a matrix phase, and exhibit a strength-improving effect due to precipitation strengthening and an effect of maintaining a high conductivity due to reduced solid solution in Cu. Such a wire material for a connector terminal can be suitably used as a material for a connector terminal, such as a press-fit terminal, which is required to have an excellent conductive property, high rigidity, and a high spring property.

(2) According to an exemplary embodiment of the wire material for a connector terminal, the wire material for a connector terminal has a conductivity of 40% IACS or more and a tensile strength of 600 MPa or more.

The above-described embodiment has a high conductivity and a high tensile strength, and it is possible to form a connector terminal having an excellent conductive property and high strength.

(3) According to an exemplary embodiment of the wire material for a connector terminal, the ratio Fe/Ti, by mass, is 1.0 to 5.5.

In the embodiment described above, an excess or deficient amount of Fe relative to Ti is small, and Fe is incorporated properly relative to Ti. Thus, Fe and Ti exist in the form of the precipitates or the like, and the strength-improving effect due to precipitation strengthening and the effect of maintaining a high conductivity due to reduced solid solution, in particular, of Ti, in Cu can be achieved. Therefore, according to the above-described embodiment, it is possible to form a connector terminal having an excellent conductive property and high strength.

(4) According to an exemplary embodiment of the wire material for a connector terminal, the wire material for a connector terminal further contains 10 to 500 ppm by mass in total of at least one element selected from the group consisting of C, Si, and Mn.

C, Si, and Mn each can function as a deoxidizing agent for elements such as Fe and Ti. Since the above-described embodiment contains C, Si, and Mn in a specific range, oxidation of Fe, Ti, and the like is decreased or prevented by the deoxidizing effect of these elements, and the effect of achieving a high conductive property and high strength due to incorporation of Fe and Ti can be appropriately obtained. Furthermore, in the above-described embodiment, from the standpoint of being able to suppress a decrease in conductivity due to incorporation of excessive amounts of C, Si, and Mn, an excellent conducting property is obtained. Therefore, according to the above-described embodiment, it is possible to form a connector terminal having an excellent conductive property and high strength.

(5) According to an exemplary embodiment of the wire material for a connector terminal, the wire material for a connector terminal has a stress relaxation rate of 30% or less after it has been held at 150° C. for 1,000 hours.

According to the above-described embodiment, even in the case where the wire material is held at a high temperature, such as 150° C., for a long period of time, such as 1,000 hours, stress relaxation is unlikely to occur, and it is possible to form a connector terminal having an excellent conductive property and high strength and also having excellent stress relaxation resistance.

(6) According to an exemplary embodiment of the wire material for a connector terminal, the wire material for a connector terminal has a lateral cross-sectional area of 0.1 to 2.0 mm².

The above-described embodiment is of a size that is easily used for a material for a connector terminal, such as a press-fit terminal, and can be suitably used as a material for the connector terminal.

(7) According to an exemplary embodiment of the wire material for a connector terminal, the wire material for a connector terminal is a rectangular wire whose lateral cross-sectional shape is quadrilateral.

The above-described embodiment is of a shape that is easily used for a material for a connector terminal, such as a press-fit terminal, and can be suitably used as a material for the connector terminal.

(8) According to an exemplary embodiment of the wire material for a connector terminal, the wire material for a connector terminal has a plating layer containing at least one of Sn and Ag on at least a part of a surface thereof.

When the above-described embodiment is used as a material for a connector terminal, such as a press-fit terminal, it is possible to easily manufacture a plated connector terminal provided with a plating layer made of metal containing Sn or Ag, such as a tin plating layer or silver plating layer, on the surface thereof. Accordingly, in the above-described embodiment, a step of forming a plating layer can be omitted after terminal formation, which contributes to improvement in productivity of the plated connector terminal.

[Detailed Description of Embodiments of the Present Invention]

The embodiments of the present invention will be described in detail below. The element contents are expressed as mass ratio (% by mass or ppm by mass) unless otherwise noted.

[Copper Alloy Wire]

(Composition)

A wire material for a connector terminal according to an embodiment (hereinafter, may be referred to as a “copper alloy wire”) is used as a material for a connector terminal, such as a press-fit terminal, and a characteristic thereof is that it is composed of a copper alloy containing specific elements in specific ranges. The copper alloy is an Fe—Ti—Cu alloy or Fe—Ti—Mg—Cu alloy containing 0.1% to 1.5% of Fe, 0.05% to 0.7% of Ti, and 0% to 0.5% of Mg, with the balance being Cu and impurities. The impurities refer to mainly impurities that are unavoidably included. First, the individual additional elements will be described in detail.

Fe

Fe is mainly precipitated in Cu, which is a matrix phase, and contributes to improvement in strength such as tensile strength.

When the Fe content is 0.1% or more, compounds and the like containing Fe and Ti can be satisfactorily formed, and it is possible to produce a copper alloy wire having excellent strength due to precipitation strengthening. Furthermore, the precipitation suppresses solid solution of Ti in the matrix phase, and it is possible to produce a copper alloy wire having a high conductivity. Although depending on the amount of Ti and production conditions, as the Fe content increases, the strength of the copper alloy wire more easily increases. When there is a requirement for higher strength or the like, the Fe content can be set at 0.6% or more, 0.7% or more, 0.9% or more, or 1.1% or more. When the Fe content is 1.5% or less, it is possible to easily suppress coarsening of precipitates containing Fe and Ti due to excessive Fe. Consequently, fracture starting from coarse precipitates can be reduced, resulting in excellent strength, and in the manufacturing process, wire breaking can be reduced during drawing and the like, resulting in excellent manufacturability. Although depending on the amount of Ti and production conditions, as the Fe content decreases, coarsening of the precipitates and the like can be more easily suppressed. When there is a requirement for suppression of coarsening of precipitates (reduction of fracture and wire breaking), the Fe content can be set at 1.3% or less, 1.2% or less, or 1.0% or less.

Ti

Ti mainly exists as precipitates together with Fe, and contributes to improvement in strength such as tensile strength.

When the Ti content is 0.05% or more, precipitates and the like containing Fe and Ti can be satisfactorily formed, and it is possible to produce a copper alloy wire having excellent strength due to precipitation strengthening. Furthermore, the precipitation decreases the amount of solid solution of Ti in the matrix phase, and it is possible to produce a copper alloy wire having a high conductivity. Although depending on the amount of Fe and production conditions, as the Ti content increases, the strength of the copper alloy wire more easily increases. When there is a requirement for higher strength or the like, the Ti content can be set at 0.1% or more, 0.25% or more, 0.3% or more, 0.4% or more, or 0.5% or more.

When the Ti content is 0.7% or less, it is possible to easily suppress coarsening of precipitates containing Fe and Ti, and fracture can be reduced, resulting in excellent strength. Wire breaking can also be reduced, resulting in excellent manufacturability. Furthermore, solid solution of excessive Ti in the matrix phase is reduced, and it is possible to produce a copper alloy wire having a high conductivity. Although depending on the amount of Fe and production conditions, as the Ti content decreases, the coarsening and the like can be more easily suppressed. When there is a requirement for suppression of coarsening of precipitates (reduction of fracture and wire breaking), the Ti content can be set at 0.6% or less, 0.55% or less, 0.5% or less, or 0.4% or less.

Fe/Ti

In addition to incorporation of Fe and Ti in the specific ranges described above, preferably, Fe is incorporated properly relative to Ti. When the Fe content is equal to or greater than the Ti content, solid solution of excessive Ti in the matrix phase and a decrease in conductivity can be easily suppressed, and it is possible to reliably produce a copper alloy wire having a high conductivity. Furthermore, in the case where Fe is not incorporated properly, there is a concern that elemental Fe may be precipitated or precipitates containing Fe and Ti may be coarsened, and the strength-improving effect due to precipitation strengthening may not be obtained properly. However, when Fe is incorporated properly relative to Ti, the two elements can exist as compounds or the like having proper sizes in the matrix phase, and a high conductive property and high strength can be satisfactorily expected. Specifically, the ratio of the Fe content to the Ti content, Fe/Ti, may be in the range of 1.0 to 5.5, in ratio by mass.

When the ratio Fe/Ti is 1.0 or more, as described above, the strength-improving effect due to precipitation strengthening can be satisfactorily obtained, resulting in excellent strength. When there is a requirement for higher strength or the like, the ratio Fe/Ti can be set at 1.5 or more, 1.8 or more, or 2.0 or more. In particular, when the ratio Fe/Ti is 2.0 or more, the conductive property tends to be more excellent, and the ratio Fe/Ti can be set at about 2.3, for example, 2.0 to 2.6.

When the ratio Fe/Ti is 5.5 or less, excessive incorporation of Fe relative to Ti can be suppressed, and the coarsening can be easily suppressed. When there is a requirement for suppression of coarsening of precipitates and the like, the ratio Fe/Ti can be set at 5.0 or less, 4.0 or less, or 3.8 or less.

Mg

In the copper alloy constituting the wire material for a connector terminal according to the embodiment, the Mg content may be 0%, that is, the copper alloy may not contain Mg. In this embodiment, by adjusting the amount of Fe, the amount of Ti, and production conditions, it is possible to produce a copper alloy wire having a high conductivity and high strength (refer to Test Example 1 which will be described later). Furthermore, in this embodiment, by suppressing a decrease in conductivity due to incorporation of Mg, a higher conductive property is obtained.

On the other hand, when Mg is incorporated in the case where Fe and Ti are incorporated in specific ranges, Mg mainly exists as a solid solution in Cu, which is a matrix phase, and tends to contribute to improvement in strength such as tensile strength. Consequently, when the copper alloy constituting the wire material for a connector terminal according to the embodiment contains Mg (more than 0%), a further increase in strength can be expected. Although depending on production conditions, as the Mg content increases, tensile strength tends to increase, resulting in higher strength. When there is a requirement for much higher strength or the like, the Mg content can be set at 0.03% or more, 0.05% or more, 0.1% or more, or 0.2% or more.

In the case where Mg is incorporated, when the Mg content is 0.5% or less, by suppressing a decrease in conductivity due to excessive solid solution of Mg in Cu, it is possible to produce a copper alloy wire having a high conductivity. Furthermore, by suppressing a decrease in workability due to excessive solid solution of Mg, plastic processing, such as drawing, can be easily performed, resulting in excellent manufacturability. When there is a requirement for a high conductive property, good workability, and the like, the Mg content can be set at 0.2% or less, 0.15% or less, or 0.1% or less.

C, Si, and Mn

The copper alloy constituting the wire material for a connector terminal according to the embodiment can contain elements that have a deoxidizing effect on Fe, Ti, and the like. Specifically, the copper alloy may contain 10 to 500 ppm by mass in total of at least one element selected from the group consisting of C, Si, and Mn.

If a manufacturing process is performed in an oxygen-containing environment, such as the atmosphere, there is a concern that elements such as Fe and Ti may be oxidized. When these elements become oxides, they cannot properly form the precipitates and the like or cannot form a solid solution in the matrix phase. Thus, there is a concern that the effects due to incorporation of these elements, such as a high conductive property and high strength, may not be obtained properly. There is also a concern that the oxides may act as starting points for fracture during drawing or the like, leading to lower manufacturability. In contrast, by incorporating at least one element of C, Mn, and Si, preferably two elements (in this case, C and Mn, or C and Si are preferable), more preferably all the three elements in a specific range, a high conductive property can be secured by precipitation of Fe and Ti, and higher strength can be achieved by precipitation strengthening. Thus, it is possible to produce a copper alloy wire having an excellent conductive property and high strength.

When the total content is 10 ppm or more, oxidation of the above-described elements can be prevented. As the total content increases, the oxidation prevention effect can be more easily obtained, and the total content can be set at 20 ppm or more, or 30 ppm or more.

When the total content is 500 ppm or less, a decrease in the conductive property due to excessive incorporation of these deoxidizing elements is unlikely to be caused, resulting in an excellent conductive property. As the total content decreases, the decrease in the conductive property can be more easily suppressed, and therefore, the total content can be set at 300 ppm or less, 200 ppm or less, or 100 ppm or less.

The content of only C is preferably 10 to 300 ppm, 10 to 200 ppm, or 30 to 150 ppm.

The content of only Mn or the content of only Si is preferably 5 to 100 ppm, or more than 5 ppm and 50 ppm or less. The total content of Mn and Si is preferably 10 to 200 ppm, or more than 10 ppm and 100 ppm or less.

When C, Mn, and Si are each incorporated in the range described above, a satisfactory oxidation prevention effect for the elements such as Fe can be easily obtained. For example, the oxygen content in the copper alloy can be set at 20 ppm or less, 15 ppm or less, or 10 ppm or less.

(Structure)

In a structure of the copper alloy constituting the wire material for a connector terminal according to the embodiment, for example, precipitates or crystallized products containing Fe and Ti may be distributed. When the copper alloy has such a structure, an increase in strength due to precipitation strengthening and securement of high conductivity due to reduced solid solution of Ti and the like in Cu can be expected.

(Cross-sectional shape)

The lateral cross-sectional shape of the wiring material for a connector terminal according to the embodiment can be appropriately selected depending on the shape of a connector terminal for which the wiring material serves as a material. Typically, the wiring material is a rectangular wire whose lateral cross-sectional shape is quadrilateral, such as rectangular or square. The lateral cross-sectional shape can be changed by adjusting plastic processing conditions. For example, in the case where a die is used, by appropriately selecting the shape of the die, in addition to the rectangular wire, a wire material whose lateral cross-sectional shape is circular, elliptical, polygonal such as hexagonal, or the like can be produced.

(Size)

The size of the wire material for a connector terminal according to the embodiment can be appropriately selected within a range in which a connector terminal for which the wiring material serves as a material can be obtained. For example, in the case where a press-fit terminal is produced from the wire material as a material, the wire material may be cut into a predetermined shape and size. When used as the material for such a connector terminal, the size may be selected so as to include portions to be removed by cutting. For example, the wire material for a connector terminal may have a lateral cross-sectional area of 0.1 to 2.0 mm², or the rectangular wire may have a width of about 0.1 to 3.0 mm and a thickness of about 0.1 to 3.0 mm.

(Characteristics)

The wire material for a connector terminal according to the embodiment is composed of a copper alloy having the specific composition described above and is excellent in terms of both the conductive property and strength. Quantitatively, the wire material for a connector terminal has at least one, and preferably both, of a conductivity of 40% IACS or more and a tensile strength of 600 MPa or more.

When there is a requirement for a higher conductivity, the conductivity can be set at 45% IACS or more, 48% IACS or more, or 50% IACS or more.

When there is a requirement for higher strength, the tensile strength can be set at 620 MPa or more, 640 MPa or more, 660 MPa or more, or 680 MPa or more.

Since the wire material for a connector terminal according to the embodiment is composed of a copper alloy having the specific composition described above, even when held at a high temperature for a long period of time, stress relaxation is unlikely to occur. Quantitatively, the wire material for a connector terminal may have a stress relaxation rate of 30% or less after it has been held at 150° C. for 1,000 hours. In this case, the bending stress in the stress relaxation test may be set at, for example, 50% of the 0.2% proof stress. The connector terminal formed of such a wire material for a connector terminal can satisfactorily maintain an electrical and mechanical connection state with a printed circuit board or the like even if held at a high temperature of about 150° C. for a long period of time during use. That is, the wire material for a connector terminal can form a connector terminal having a high conductivity, high strength, and excellent stress relaxation resistance.

When there is a requirement for higher stress relaxation resistance, the stress relaxation rate can be set at 28% or less, or 25% or less. The method for measuring the stress relaxation rate will be described later.

The conductivity, tensile strength, stress relaxation rate, and the like can be set at predetermined values by adjusting the composition and production conditions. For example, when the amounts of Fe, Ti, and Mg (as appropriate) are increased, or the degree of drawing is increased (the wire material is thinned), the tensile strength tends to increase. For example, when a heat treatment is performed during processing, the conductivity may be increased in some cases (refer to samples subjected to a softening treatment in Test Example 1 which will be described later). When the tensile strength and the like are increased, the stress relaxation rate tends to increase.

(Surface Layer)

The wire material for a connector terminal according to the embodiment can be directly used as a material for a connector terminal, such as a press-fit terminal. The wire material for a connector terminal according to the embodiment can be produced as a plated wire material which has a plating layer on at least a part of a surface thereof. By using the plated wire material as the material, a plated connector terminal can be easily manufactured, which contributes to improvement in manufacturability of the plated connector terminal. A plated wiring material having a plating layer can be used only for portions requiring plating in a plated connector terminal. However, when a plated wiring material having a plating layer on the entire surface thereof is produced, the plating operation is easy to perform, resulting in excellent manufacturability. In the process for producing a plated wire material having a plating layer on the entire surface thereof, the plating layer can be formed on a wire material of final shape and size. On the other hand, plating may be performed on the material at a stage prior to the final stage, and after the plating, plastic processing for obtaining a wire material of final shape and size may be performed. In this case, since the object to be plated is a material having a simple shape and a relatively large size, plating can be easily performed, and a plated wire material provided with a plating layer with a uniform thickness can be easily obtained.

The plating layer in the plated connector terminal adheres to a connection target of the connector terminal (e.g., a conductor of a through-hole portion or the like of a printed circuit board, typically composed of copper or a copper alloy) and functions to maintain a good conducting state. Accordingly, as the constituent metal of the plating layer of the plated wire material, a metal having this function can be suitably used. In particular, when a plating layer containing at least one of Sn and Ag is provided, excellent adhesion to the connector terminal and excellent adhesion to the connection target of the connector terminal can be achieved, which is preferable. Specifically, the plating layer may be composed of at least one metal selected from the group consisting of tin, a tin alloy, silver, and a silver alloy. As an underlying layer for the plating layer containing Sn and Ag, at least one of a nickel plating layer and a copper plating layer can be provided.

The thickness of the plating layer (the total thickness of the underlying layer and the plating layer when the underlying layer is provided) can be appropriately selected, and is, for example, about 0.3 to 5 μm. In this range, the good adhesion due to the presence of the plating layer can be exhibited, and by suppressing detachment due to an excessive thickness, the plating layer can be easily maintained.

(Uses)

The wire material for a connector terminal according to the embodiment can be used as a material for various connector terminals. In particular, the wire material can be used as a material for a press-fit terminal and the like. Connector terminals are required to have an excellent conductive property, excellent rigidity, and an excellent spring property, in other words, excellent strength, and therefore, the wire material for a connector terminal according to the embodiment is suitable as a material therefor. In addition, the wire material for a connector terminal is expected to be used in various fields requiring excellence in both a conductive property and strength.

[Advantageous effects]

The wire material for a connector terminal according to the embodiment is composed of a copper alloy having a specific composition and therefore, has an excellent conductive property and high strength. These advantageous effects will be specifically described in Test Example 1. By using such a wire material for a connector terminal as a material for a connector terminal and appropriately subjecting the wire material to cutting and the like, it is possible to provide a connector terminal having an excellent conductive property and high strength. Furthermore, because of high strength, it is expected that a connector terminal having excellent stress relaxation resistance can be provided.

[Production method]

The wire material for a connector terminal according to the embodiment can be produced, for example, by a production method including the steps described below. The outline of the individual steps will be described below, and then each of the steps will be described in detail.

<Continuous casting step> A molten metal of the copper alloy having the specific composition described above is continuously cast to produce a cast material.

<Drawing step> The cast material or a processed material obtained by subjecting the cast material to working is subjected to drawing to produce a drawn material having a predetermined size.

<Forming step> The drawn material having a predetermined size is subjected to plastic processing to produce a wire material for a connector terminal having a predetermined shape.

<Heat treatment step> The material after the <continuous casting step> and before the <forming step> is subjected to an aging treatment.

In the case where a wire material for a connector terminal provided with the plating layer is produced, for example, the following <plating step> is provided, for example, before the <forming step> or after the <forming step>.

<Plating step> A plating layer containing at least one of Sn and Ag is formed on at least a part of a surface of the target wire material to produce a plated wire material.

In addition, the target material can be subjected to an intermediate heat treatment before the <drawing step>, before the <forming step>, during drawing in the case where a multi-pass drawing process is used, or the like.

<Continuous casting step>

In this step, a molten metal of the copper alloy containing Fe, Ti, and Mg (as appropriate) in specific ranges is continuously cast to produce a cast material. Here, when melting is performed in a vacuum, oxidation of elements such as Fe and Ti can be prevented. On the other hand, when melting is performed in the atmosphere, atmospheric control is not required, and productivity can be improved. In this case, in order to prevent oxidation of the elements due to oxygen in the atmosphere, the deoxidizing elements (C, Mn, and Si) are preferably used.

In a method for adding C (carbon), for example, a molten metal surface of the molten metal may be covered with charcoal pieces, charcoal powder, or the like. In this case, C can be supplied into the molten metal from charcoal pieces, charcoal powder, or the like in the vicinity of the molten metal surface.

Regarding Mn and Si, raw materials containing these elements may be separately prepared and mixed into the molten metal. In this case, even when portions exposed from gaps formed between charcoal pieces, charcoal powder particles, or the like are brought into contact with oxygen in the atmosphere, oxidation in the vicinity of the molten metal surface can be suppressed. Examples of the raw materials include elemental Mn, elemental Si, an alloy of Mn and Fe, and an alloy of Si and Fe.

In addition to incorporation of the deoxidizing elements, when a crucible and a mold, each made of high-purity carbon containing small amounts of impurities, are used, impurities are unlikely to be mixed into the molten metal, which is preferable.

In the wire material for a connector terminal according to the embodiment, typically, Fe and Ti are made to exist as precipitates, and Mg is made to exist as a solid solution when Mg is incorporated. Therefore, in the process of producing the wire material for a connector terminal, preferably, a step of forming a supersaturated solid solution is included. For example, by separately providing a solution treatment step of performing a solution treatment to form a supersaturated solid solution, a supersaturated solid solution can be formed at any time. On the other hand, by increasing the cooling rate in the continuous casting step to produce a cast material of a supersaturated solid solution, without separately providing a solution treatment step, it is possible to produce a copper alloy wire having excellent electrical and mechanical characteristics in the end. Since the number of production steps can be decreased, excellent manufacturability can be obtained. Accordingly, in the method of producing the wire material for a connector terminal, it is proposed to perform continuous casting, in particular, to increase the cooling rate in the cooling process, i.e., to perform rapid cooling.

As the continuous casting method, various methods, such as a belt and wheel method, a twin-belt method, and an up-casting method, can be used. In particular, in the up-casting method, impurities, such as oxygen, can be decreased, and oxidation of elements, such as Cu, Fe, and Ti, can be easily prevented, which is preferable. The cooling rate in the cooling process is preferably more than 5° C./sec, more than 10° C./sec, or 15° C./sec or more.

The cast material can be subjected to various types of processing, such as plastic processing and cutting. Examples of the plastic processing include conform extrusion, rolling (hot, warm, cold), and the like. Examples of the cutting include peeling and the like. By performing such processing, surface defects of the cast material can be reduced, and wire breaking and the like can be reduced during drawing, thus enabling improvement in productivity. In particular, when an up-cast material is subjected to such processing, the wire breaking and the like are unlikely to occur.

The processed material before drawing, the intermediate drawn material during drawing, the drawn material after drawing, and the like can be subjected to the intermediate heat treatment under the conditions described below.

Since the processed material has a relatively larger cross-sectional area (is thicker) than a wire material of final size, in the heat treatment, it is considered that batch processing, in which the heating state of the entire heating target is easily controlled, can be easily used.

Since the intermediate drawn material and the drawn material have a relatively small cross-section, continuous processing may be used.

{Intermediate Heat Treatment Conditions}

(Heat treatment temperature) 400° C. to 550° C., preferably, 450° C. to 500° C.

(Holding time) 4 to 16 hours, preferably, 4 to 10 hours

One purpose of the intermediate heat treatment is to remove the strain caused by processing and to soften the material so that subsequent plastic processing, such as drawing, can be easily performed, i.e., to improve workability. For this purpose, the temperature and time may be selected from the ranges described above depending on the composition and the like. By removing the strain and the like, the conductivity can be expected to be recovered, and even when plastic processing, such as drawing, is performed after the intermediate heat treatment, maintenance of a high conductivity can be expected. Furthermore, when peeling or the like is performed after the intermediate heat treatment, surface defects due to the heat treatment can be reduced.

<Drawing Step>

In this step, typically, the cast material, the processed material, an intermediate heat-treated material obtained by subjecting the processed material to the intermediate heat treatment, or the like is subjected to at least one pass, typically, multiple passes of drawing (cold), and thereby, a drawn material having a predetermined size is produced. In the case where multiple passes are performed, the degree of processing for each pass may be appropriately adjusted depending on the composition, the predetermined size, or the like. Furthermore, in the case where multiple passes are performed, the intermediate heat treatment can be performed between the passes. In this case, workability can be enhanced as described above. In the intermediate heat treatment, the temperature and time may be selected from the ranges described above depending on the composition and the like.

<Forming step>

In this step, a wire material for a connector terminal having the final shape is produced by plastic processing. The plastic processing can be rolling or the like, but can be drawing in which a die with a predetermined shape is used. In this case, a long wire material for a connector terminal can be continuously produced, which is suitable for mass production. As the die, for example, by using a modified die having a quadrilateral through-hole, a rectangular wire whose lateral cross-sectional shape is quadrilateral can be produced.

The size of the drawn material to be subjected to the forming step is preferably close to the size of a wire material for a connector terminal having the final shape. In this case, the degree of processing to obtain the final shape can be decreased, and by reducing the strain introduced by processing, it is possible to produce a wire material for a connector terminal having a high conductivity. The intermediate heat treatment can be performed before the forming step. In this case, while it is possible to form, with high accuracy, a wire material for a connector terminal having excellent workability in the forming step and having a predetermined final shape and a predetermined size, high strength can be achieved because of the strength-improving effect due to work hardening.

<Heat treatment step>

In this step, a heat treatment (aging treatment) is performed mainly for the purpose of artificial aging in which precipitates containing Fe and Ti are precipitated from the material (typically, a supersaturated solid solution). The heat treatment can satisfactorily achieve a strength-improving effect due to precipitation strengthening by the precipitates and the like and an effect of maintaining a high conductivity due to reduced solid solution in Cu. Furthermore, softening can be expected to a certain extent by the heat treatment, and excellent workability is exhibited when plastic processing, such as drawing, is performed after the heat treatment.

The heat treatment (aging treatment) can be performed at any time after the continuous casting step. Specifically, the treatment may be performed before the <drawing step> (heat treatment target: the cast material or the processed material), during drawing (heat treatment target: an intermediate drawn material), immediately after the <drawing step> (heat treatment target: a drawn material having a predetermined size), after the <forming step> (heat treatment target: a wire material having a predetermined shape), or the like. In particular, the treatment is preferably performed before the <forming step>.

Regarding the heat treatment conditions (aging conditions), it is considered that batch processing, in which the heating state is easily controlled, can be easily used. For example, the conditions are as follows:

{Aging conditions}

(Heat treatment temperature) 400° C. to 600° C., preferably, 450° C. to 550° C.

(Holding time) 4 to 16 hours, preferably, 4 to 10 hours

The conditions may be selected from the above-described ranges depending on the composition (type of additional element, content), the processed state, and the like. Regarding specific examples, refer to Test Example 1 which will be described later.

<Plating step>

In the case where a plating layer is formed on a material before the <forming step>, a plating layer can be formed, for example, on a drawn material which is a round wire having a circular cross-section, or the like. In this case, since the object to be plated has a simple shape and is thick to some extent, a plating layer with a uniform thickness can be easily formed with high accuracy, resulting in excellent manufacturability.

In the case where a plating layer is formed on a wire material having the final shape which has been subjected to the <forming step>, there is no concern that the plating layer may be damaged when subjected to plastic processing in the forming step.

The plating layer can be formed by a known method, such as electroplating or chemical (electroless) plating, depending on the desired composition. As described above, an underlying layer may be formed. The thickness of the plating layer may be adjusted such that the final thickness is a predetermined thickness.

### TEST EXAMPLE 1

Copper alloy wires having various compositions were produced under various production conditions, and their characteristics were checked.

The copper alloy wires were produced by the following three production patterns (A), (B), and (C). In all of the production patterns, the cast material described below was prepared. (Cast Material)

Electrolytic copper (purity: 99.99% or more), master alloys containing the elements shown in Table 1 or the simple elements were prepared as raw materials. The prepared raw materials were melted in the atmosphere by using a crucible made of high-purity carbon (impurity content: 20 ppm by mass or less). Thereby, molten metals of copper alloys were produced. The compositions of the copper alloys (with the balance being Cu and impurities) are shown in Table 1.

By using the molten metals of the copper alloys and a mold made of high-purity carbon (impurity content: 20 ppm by mass or less), cast materials having a circular cross-section with the wire diameter described below were produced by an up-casting method. The cooling rate was set at more than 10° C./sec.

In this test, charcoal pieces were prepared as a carbon source, and iron alloys containing Si or Mn were prepared as a Si source or Mn source. The molten metal surface of each of the molten metals was sufficiently covered with the charcoal pieces so that the molten metal surface was not brought into contact with the atmosphere. The amount of charcoal pieces was adjusted such that the amount of C mixed into the molten metal due to contact between the charcoal pieces and the molten metal surface corresponded to the content of “C” (mass ppm) under the “trace element” shown in Table 1.

Iron alloys were mixed into the molten metal while adjusting the amounts of iron alloys such that the contents of Si and Mn relative to the molten metal corresponded to the contents of “Si” and “Mn” (mass ppm) under the “trace element” shown in Table 1.

(Production Pattern of Copper Alloy Wire)

(A) continuous casting (wire diameter ϕ 12.5 mm)

conform extrusion (wire diameter ϕ 9.5 mm)

drawing (wire diameter ϕ 2.6 mm or ϕ 1.6 mm)

heat treatment (under conditions of aging treatment in Table 1)

drawing (wire diameter ϕ 1.0 mm)

intermediate heat treatment (under conditions of softening treatment in Table 1)

forming (rectangular wire drawing by using modified die, 0.64 mm ×0.64 mm, or 0.64 mm long×1.50 mm wide)

formation of tin plating layer (thickness 1.5 μm)

(B) continuous casting (wire diameter ϕ 12.5 mm)

cold rolling (wire diameter ϕ 9.5 mm)

intermediate heat treatment (temperature: selected from the range of 400° C. to 550° C., holding time: selected from the range of 4 to 16 hours)

peeling (wire diameter ϕ 8 mm)

drawing (wire diameter ϕ 2.6 mm or ϕ 1.6 mm)

heat treatment (under conditions of aging treatment in Table 1)

drawing (wire diameter ϕ 1.0 mm)

intermediate heat treatment (under conditions of softening treatment in Table 1)

forming (rectangular wire drawing by using modified die, 0.64 mm ×0.64 mm, or 0.64 mm long×1.50 mm wide)

formation of tin plating layer (thickness 1.5 μm)

(C) continuous casting (wire diameter ϕ 12.5 mm)

drawing (wire diameter ϕ 9.5 mm)

peeling (wire diameter ϕ 8 mm)

drawing (wire diameter ϕ 2.6 mm)

heat treatment (under conditions of aging treatment in Table 1)

drawing (wire diameter ϕ 1.0 mm)

intermediate heat treatment (under conditions of softening treatment in Table 1)

forming (rectangular wire drawing by using modified die, 0.64 mm ×0.64 mm, or 0.64 mm long×1.50 mm wide)

formation of tin plating layer (thickness 1.5 μm)

In production patterns (A), (B), and (C), regarding samples whose conditions of softening treatment are described in Table 1, the intermediate heat treatment (softening treatment) was conducted under the conditions shown in Table 1 at the wire diameter shown in Table 1. This intermediate heat treatment can be omitted (refer to samples in which the softening treatment column indicates “-” in Table 1).

Regarding the copper alloy wires produced in accordance with production patterns (A), (B), and (C), tensile strength (MPa) and conductivity (% IACS) were checked. The results are shown in Table 2.

The tensile strength (MPa) was measured in accordance with JIS Z 2241 (Metal material tensile test method, 1998) by using a general-purpose tensile tester. The conductivity (% IACS) was measured by a bridge method.

TABLE 1

| | Composition | | | | mass | Trace | | | | Aging treatment | | | Softening treatment | | |
|---|---|---|---|---|---|---|---|---|---|---|---|---|---|---|---|
| | Additional element | | | | ratio | element | | | | Wire | Temper- | | Wire | Temper- | |
| | mass % | | | | Fe/ | mass ppm | | | | diameter | ature | Time | diameter | ature | Time |
| No | Cu | Fe | Ti | Mg | Ti | C | Mn | Si | Process | mm | ° C. | h | mm | ° C. | h |
| 1-1 | Bal. | 1.12 | 0.48 | 0.34 | 2.3 | 30 | <10 | <10 | A | 2.6 | 500 | 8 | — | — | — |
| 1-2 | Bal. | 1.12 | 0.48 | 0.34 | 2.3 | 30 | <10 | <10 | A | 2.6 | 500 | 8 | — | — | — |
| 1-3 | Bal. | 1.12 | 0.48 | 0.34 | 2.3 | 30 | <10 | <10 | A | 2.6 | 500 | 8 | ϕ1.0 | 500 | 4 |
| 1-4 | Bal. | 1.03 | 0.31 | 0.039 | 3.3 | 10 | <10 | <10 | A | 1.6 | 500 | 8 | — | — | — |
| 1-5 | Bal. | 1.03 | 0.31 | 0.039 | 3.3 | 10 | <10 | <10 | A | 1.6 | 500 | 8 | — | — | — |
| 1-6 | Bal. | 1.03 | 0.31 | 0.039 | 3.3 | 10 | <10 | <10 | B | 1.6 | 500 | 8 | ϕ1.0 | 500 | 4 |
| 1-7 | Bal. | 1 | 0.41 | 0.054 | 2.4 | 20 | <10 | <10 | B | 1.6 | 550 | 8 | — | — | — |
| 1-8 | Bal. | 1 | 0.41 | 0.054 | 2.4 | 20 | <10 | <10 | B | 1.6 | 550 | 8 | — | — | — |
| 1-9 | Bal. | 0.64 | 0.29 | 0.05 | 2.2 | 60 | <10 | <10 | B | 2.6 | 500 | 8 | — | — | — |
| 1-10 | Bal. | 0.64 | 0.29 | 0.05 | 2.2 | 60 | <10 | <10 | B | 2.6 | 500 | 8 | — | — | — |
| 1-11 | Bal. | 0.66 | 0.3 | 0 | 2.2 | 20 | <10 | <10 | A | 2.6 | 500 | 8 | — | — | — |
| 1-12 | Bal. | 0.66 | 0.3 | 0 | 2.2 | 20 | <10 | <10 | A | 2.6 | 500 | 8 | — | — | — |
| 1-13 | Bal. | 1 | 0.45 | 0 | 2.2 | 50 | <10 | <10 | A | 2.6 | 500 | 8 | — | — | — |
| 1-14 | Bal. | 1 | 0.45 | 0 | 2.2 | 50 | <10 | <10 | A | 2.6 | 500 | 8 | — | — | — |
| 1-15 | Bal. | 1 | 0.46 | 0.31 | 2.2 | 40 | <10 | <10 | C | 2.6 | 500 | 8 | — | — | — |
| 1-16 | Bal. | 1 | 0.46 | 0.31 | 2.2 | 40 | <10 | <10 | C | 2.6 | 500 | 8 | — | — | — |
| 1-17 | Bal. | 1 | 0.46 | 0.31 | 2.2 | 40 | <10 | <10 | C | 2.6 | 500 | 8 | ϕ1.0 | 500 | 4 |
| 1-101 | Bal. | 0.05 | 0.1 | 0 | 0.5 | 60 | <10 | <10 | A | 2.6 | 500 | 8 | — | — | — |
| 1-102 | Bal. | 0.01 | 0.05 | 0 | 0.2 | 30 | <10 | <10 | A | 2.6 | 500 | 8 | — | — | — |
| 1-103 | Bal. | 2 | 0.05 | 0.05 | 40 | 40 | <10 | <10 | A | 2.6 | 500 | 8 | — | — | — |
| 1-104 | Bal. | 1 | 0.1 | 0 | 10 | 25 | <10 | <10 | A | 2.6 | 500 | 8 | — | — | — |

TABLE 2

| | Composition | | | | mass | Trace | | | | Size of | Characteristics | |
|---|---|---|---|---|---|---|---|---|---|---|---|---|
| | Additional | | | | ratio | element | | | | final wire | Tensile | Conduc- |
| | element mass % | | | | Fe/ | mass ppm | | | | material | strength | tivity |
| No. | Cu | Fe | Ti | Mg | Ti | C | Mn | Si | Process | mm × mm | MPa | % IACS |
| 1-1 | Bal. | 1.12 | 0.48 | 0.34 | 2.3 | 30 | <10 | <10 | A | 0.64 × 0.64 | 734 | 55 |
| 1-2 | Bal. | 1.12 | 0.48 | 0.34 | 2.3 | 30 | <10 | <10 | A | 0.64 × 1.50 | 737 | 59 |
| 1-3 | Bal. | 1.12 | 0.48 | 0.34 | 2.3 | 30 | <10 | <10 | A | 0.64 × 0.64 | 693 | 63 |
| 1-4 | Bal. | 1.03 | 0.31 | 0.039 | 3.3 | 10 | <10 | <10 | A | 0.64 × 0.64 | 697 | 64 |
| 1-5 | Bal. | 1.03 | 0.31 | 0.039 | 3.3 | 10 | <10 | <10 | A | 0.64 × 1.50 | 700 | 66 |
| 1-6 | Bal. | 1.03 | 0.31 | 0.039 | 3.3 | 10 | <10 | <10 | B | 0.64 × 0.64 | 682 | 66 |
| 1-7 | Bal. | 1 | 0.41 | 0.054 | 2.4 | 20 | <10 | <10 | B | 0.64 × 0.64 | 788 | 68 |
| 1-8 | Bal. | 1 | 0.41 | 0.054 | 2.4 | 20 | <10 | <10 | B | 0.64 × 1.50 | 770 | 69 |
| 1-9 | Bal. | 0.64 | 0.29 | 0.05 | 2.2 | 60 | <10 | <10 | B | 0.64 × 0.64 | 769 | 51 |
| 1-10 | Bal. | 0.64 | 0.29 | 0.05 | 2.2 | 60 | <10 | <10 | B | 0.64 × 1.50 | 765 | 61 |
| 1-11 | Bal. | 0.66 | 0.3 | 0 | 2.2 | 20 | <10 | <10 | A | 0.64 × 0.64 | 750 | 54 |
| 1-12 | Bal. | 0.66 | 0.3 | 0 | 2.2 | 20 | <10 | <10 | A | 0.64 × 1.50 | 748 | 65 |
| 1-13 | Bal. | 1 | 0.45 | 0 | 2.2 | 50 | <10 | <10 | A | 0.64 × 0.64 | 760 | 54 |
| 1-14 | Bal. | 1 | 0.45 | 0 | 2.2 | 50 | <10 | <10 | A | 0.64 × 1.50 | 759 | 65 |
| 1-15 | Bal. | 1 | 0.46 | 0.31 | 2.2 | 40 | <10 | <10 | C | 0.64 × 0.64 | 990 | 44 |
| 1-16 | Bal. | 1 | 0.46 | 0.31 | 2.2 | 40 | <10 | <10 | C | 0.64 × 1.50 | 994 | 52 |
| 1-17 | Bal. | 1 | 0.46 | 0.31 | 2.2 | 40 | <10 | <10 | C | 0.64 × 0.64 | 960 | 61 |
| 1-101 | Bal. | 0.05 | 0.1 | 0 | 0.5 | 60 | <10 | <10 | A | 0.64 × 0.64 | 520 | 20 |
| 1-102 | Bal. | 0.01 | 0.05 | 0 | 0.2 | 30 | <10 | <10 | A | 0.64 × 0.64 | 302 | 22 |
| 1-103 | Bal. | 2 | 0.05 | 0.05 | 40 | 40 | <10 | <10 | A | 0.64 × 0.64 | 750 | 15 |
| 1-104 | Bal. | 1 | 0.1 | 0 | 10 | 25 | <10 | <10 | A | 0.64 × 0.64 | 732 | 11 |

Comparisons are made between final wire materials with the same size in the description below.

As is obvious from Table 2, the copper alloy wires of samples Nos. 1-1 to 1-17 have an excellent conductive property and high strength compared with samples Nos. 1-101 to 1-103. Quantitatively, in all of samples Nos. 1-1 to 1-17, the conductivity is 40% IACS or more, and the tensile strength is 600 MPa or more. One reason for this is considered to be that, in each of samples Nos. 1-1 to 1-17, the wire is composed of a copper alloy having a specific composition containing Fe, Ti, and Mg (as appropriate) in the specific ranges. Consequently, it is considered that the strength-improving effect due to precipitation strengthening based on incorporation of Fe and Ti and the effect of maintaining the conductivity of Cu due to reduced solid solution of Ti and the like in the matrix phase are obtained, and also that the strength-improving effect due to solid-solution strengthening of Mg (as appropriate) is obtained. Another reason for this is considered to be that, in each of samples Nos. 1-1 to 1-17, incorporation of appropriate amounts of C, Mn, and Si can prevent oxidation of Fe, Ti, and the like, and the strength-improving effect due to precipitation strengthening based on incorporation of Fe and Ti and the effect of maintaining the conductivity of Cu due to reduced solid solution in the matrix phase can be easily obtained.

Regarding the conductivity, all of samples Nos. 1-1 to No. 1-17 have a conductivity of 42% IACS or more, many samples have a conductivity of 45% IACS or more, and many samples have a conductivity of 50% IACS or more, or 54% IACS or more. Furthermore, there are many samples having a conductivity of 60% IACS or more.

Regarding the tensile strength, all of samples Nos. 1-1 to No. 1-17 have a tensile strength of 650 MPa or more, or more than 680 MPa, and many samples have a tensile strength of 690 MPa or more, or 700 MPa or more. Furthermore, there are samples having a tensile strength of 750 MPa or more, 800 MPa or more, or 900 MPa or more.

Attention will be paid to compositions.

For example, when samples Nos. 1-7 and 1-8 are compared with samples Nos. 1-9 and 1-10, samples Nos. 1-7 and 1-8 having high contents of Fe and Ti have both a high conductivity and a high tensile strength. One reason for this is considered to be that, precipitates containing Fe and Ti can be satisfactorily formed, and the strength-improving effect due to precipitation strengthening and the effect of maintaining the conductivity of Cu due to suppressed solid solution in Cu can be obtained.

When samples Nos. 1-9 and 1-10 which contain Mg in addition to Fe and Ti are compared with samples Nos. 1-11 and 1-12 which do not contain Mg, it is evident that samples Nos. 1-9 and 1-10 containing Mg have more excellent strength. Similarly, when samples Nos. 1-15 and 1-16 which contain Mg are compared with samples Nos. 1-13 and 1-14 which do not contain Mg, it is evident that samples Nos. 1-15 and 1-16 containing Mg have more excellent strength. Furthermore, when samples Nos. 1-7 and 1-8 containing Mg are compared with samples Nos. 1-15 and 1-16, it is evident that as the Mg content increases, strength increases. In this test, in samples Nos. 1-15 to 1-17 containing Mg in an amount of 0.2% by mass or more, or 0.3% by mass or more, the tensile strength is 950 MPa or more, indicating very high strength. On the other hand, in the case where Mg is not incorporated, it is evident that the conductivity is likely to increase.

Regarding sample No. 1-104, in comparison with samples Nos. 1-1 to 1-17, the conductivity is low. One reason for this is considered to be that, in sample No. 1-104, the ratio Fe/Ti, by mass, is 10. Regarding sample No. 1-103, in comparison with samples Nos. 1-1 to 1-17, the conductivity is low. One reason for this is considered to be that, in sample No. 1-103, the Fe content is excessively high and the ratio Fe/Ti, by mass, is excessively large. On the other hand, in samples Nos. 1-101 and 1-102 in which the Fe content is low and the ratio Fe/Ti is small at 0.5 or less, the strength is poor. From these results, it is considered that the Fe content is preferably more than 0.05% and less than 2%, and the ratio Fe/Ti is preferably more than 0.5 and less than 10, more preferably 1.0 to 5.5.

Furthermore, from this test, it is considered that, when the C content is 60 ppm by mass or less, the total content of Mn and Si is 20 ppm by mass or less, and the total content of the three elements is 100 ppm by mass or less, in particular 80 ppm by mass or less, decreases in conductivity and strength due to incorporation of these elements are unlikely to be caused, and on the contrary, Fe and Ti can be made to function properly.

Regarding the heat treatment, this test shows that, in samples Nos. 1-3, 1-6, and 1-17 in which the intermediate heat treatment (softening treatment) was performed on the material having a predetermined size, the conductivity tends to be increased compared with the case where the intermediate heat treatment was not performed (samples Nos. 1-1, 1-4, and 1-15). Furthermore, this test shows that, even in the case where Mg is incorporated, by performing the intermediate heat treatment after processing, such as drawing, the conductivity may be improved (e.g., refer to sample No. 1-3).

Furthermore, the wire materials of samples Nos. 1-1 to 1-17 have excellent stress relaxation resistance. Here, the stress relaxation rate was checked on the wire materials of samples Nos. 1-1 and 1-6, a wire material made of phosphor bronze, and a wire material made of brass by the following procedure.

The stress relaxation rate is measured by a cantilever method with reference to the Japan Copper and Brass Association technical standard “Standard method for stress relaxation test by bending for thin sheets and strips” (JCBA, T309: 2004). A sample is subjected to a predetermined bending stress, the resulting curved sample, in a state of being held by a holding block, is placed in a heating furnace, and the heat resistance test described below is performed. The heat resistance test conditions are as follows: the predetermined bending stress at 50% of the 0.2% proof stress, the heating temperature at 150° C., and the holding time selected from the range of 10 to 1,000 hours.

From the initial set δ₀ (mm) of the specimen required to obtain the predetermined bending stress and the permanent set δₜ (mm) described below, the stress relaxation rate (%)=(permanent set δₜ/initial set δ₀)×100 is obtained. The permanent set δₜ is defined as the set of the specimen occurring when the bending stress is released after the heat resistance test.

As the wire material of phosphor bronze (C5191) and the wire material of brass (C2600), commercially available materials (0.64 mm ×0.64 mm) were prepared.

Table 3 shows characteristics [conductivity (% IACS), tensile strength (MPa), and 0.2% proof stress (MPa)] of the wire material of each sample, and the stress relaxation rate (%) for each holding time. The characteristics of the wire material of each sample were measured by the metal material tensile test method and the bridge method.

TABLE 3

| | | Characteristics | | | | | | | | |
|---|---|---|---|---|---|---|---|---|---|---|
| | | Conduc- | | 0.2% | | | | | | |
| | | tivity | Tensile | proof | Stress relaxation rate (%) | | | | | |
| Sam- | Com- | % | strength | stress | 25 | 50 | 100 | 200 | 500 | 1000 |
| ple | position | IACS | MPa | MPa | h | h | h | h | h | h |
| 1-1 | Fe—Ti— | 55 | 734 | 705 | 17 | 18 | 19 | 21 | 21 | 21 |
| | Mg—Cu | | | | | | | | | |
| 1-6 | Fe—Ti— | 66 | 682 | 653 | 15 | 15 | 16 | 17 | 17 | 17 |
| | Mg—Cu | | | | | | | | | |
| 1-201 | C5191 | 13 | 718 | 636 | 23 | 24 | 28 | 30 | 37 | 43 |
| | (Phosphor | | | | | | | | | |
| | bronze) | | | | | | | | | |
| 1-202 | C2600 | 25 | 721 | 571 | 40 | 41 | 45 | 47 | 52 | 56 |
| | (Brass) | | | | | | | | | |

As shown in Table 3, the wire materials of samples Nos. 1-1 and 1-6 each have a high conductive property and high strength in a well-balanced manner and a low stress relaxation rate, indicating that stress relaxation is unlikely to occur, compared with sample No. 1-201 of phosphor bronze and sample No. 1-202 of brass. In particular, in samples Nos. 1-1 and 1-6, the stress relaxation rate is lower than that of sample No. 1-201 of phosphor bronze which is considered to have an excellent spring property, and the stress relaxation rate is 30% or less, or 25% or less even after elapse of 1,000 hours. In particular, in sample No. 1-6, the stress relaxation rate after elapse of 1,000 hours is lower at 20% or less. One reason for such excellent stress relaxation resistance is considered to be that, since samples Nos. 1-1 and 1-6 each are composed of a copper alloy having the specific composition, the 0.2% proof stress is higher than that of phosphor bronze. Furthermore, from this test, it is also anticipated that, regarding the wire materials of samples Nos. 1-2 to 1-5 and Nos. 1-7 to 1-17, stress relaxation is unlikely to occur.

Furthermore, even in the case where the stress relaxation rate is measured by using a bending stress-applying jig of both-end supporting type described below, instead of using the cantilever method, it is anticipated that the wire materials of samples Nos. 1-1 to 1-17 each have a low stress relaxation rate, and stress relaxation is unlikely to occur. The jig is U-shaped and includes a substrate having a length L_{S} that is shorter than the length L₀ of a sample (wire material) and supporting legs which protrude from both ends of the substrate. The sample is arranged so as to extend between the two supporting legs, and both ends of the sample are fixed. A sample is subjected to a predetermined bending stress (e.g., 80% of the proof stress), the resulting curved sample is arranged between the supporting legs, and both ends of the sample are fixed to the jig. The sample in the predetermined bending stress-applied state, together with the jig, is placed in a heating furnace, and the heat resistance test described below is performed. The heat resistance test conditions are as follows: the heating temperature at 150° C., and the holding time selected from the range of 10 to 1,000 hours. As described above, the stress relaxation rate is obtained from the initial set and the permanent set.

For example, in the case where the predetermined bending stress is set at 80% of the proof stress, the heating temperature in the heat resistance test is set at 150° C., and the holding time is set at 100 hours, the stress relaxation rate of brass (C2600-H) is about 60% to 55%. This stress relaxation rate of brass is the value described in the material characteristic database of copper and brass sheets and strips (Japan Copper and Brass Association). Under the same heating conditions (150° C.×100 hours), the stress relaxation rate (both end-supported) of the wire material of each of samples Nos. 1-1 to 1-17 can be 30% or less. That is, even in the case where both ends are supported, it is anticipated that the wire material has more excellent stress relaxation resistance than brass.

This test shows that the copper alloy wire composed of a copper alloy containing Fe, Ti, and Mg (as appropriate) in specific ranges has a high conductivity and high strength. Furthermore, this test shows that, by selecting a specific composition and performing a specific heat treatment at least including an aging treatment, it is possible to obtain a wire material having a high conductivity and high strength. In particular, as in this test example, by combining a solution treatment step with the continuous casting step, and by forming the final shape by drawing using a modified die, the number of steps can be decreased, and a long wire material can be continuously produced. Thus, excellent manufacturability is achieved.

The scope of the present invention is not limited to the embodiments described above but is defined by the appended claims, and is intended to include all modifications within the meaning and scope equivalent to those of the claims.

For example, the composition of the copper alloy, the width and thickness of the rectangular wire, the heat treatment conditions, and the like in Test Example 1 can be appropriately changed.

1. A wire material for a connector terminal comprising:
0.1% to 1.5% by mass of Fe;
0.05% to 0.7% by mass of Ti; and
0% to 0.5% by mass of Mg,
with the balance being Cu and impurities.

2. The wire material for a connector terminal according to claim 1, wherein the wire material for a connector terminal has a conductivity of 40% IACS or more and a tensile strength of 600 MPa or more.

3. The wire material for a connector terminal according to claim 1, wherein the ratio Fe/Ti, by mass, is 1.0 to 5.5.

4. The wire material for a connector terminal according to claim 1, further comprising 10 to 500 ppm by mass in total of at least one element selected from the group consisting of C, Si, and Mn.

5. The wire material for a connector terminal according to claim 1, wherein the wire material for a connector terminal has a stress relaxation rate of 30% or less after it has been held at 150° C. for 1,000 hours.

6. The wire material for a connector terminal according to claim 1, wherein the wire material for a connector terminal has a lateral cross-sectional area of 0.1 to 2.0 mm².

7. The wire material for a connector terminal according to claim 1, wherein the wire material for a connector terminal is a rectangular wire whose lateral cross-sectional shape is quadrilateral.

8. The wire material for a connector terminal according to claim 1, wherein the wire material for a connector terminal has a plating layer containing at least one of Sn and Ag on at least a part of a surface thereof.
